(19) United States
(12) Patent Application Publication
(10) Pub. No.: US 2005/0178785 A1
(43) Pub. Date: Aug. 18, 2005

(54) Cosmetic package dispenser head

(75) Inventor: Gregory Alan Erickson, South Elgin, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA

(21) Appl. No.: 10/748,806

(22) Filed: Dec. 30, 2003

(51) Int. Cl. G07F 11/00; A47F 1/00

(52) U.S. Cl. 221/100

(57) ABSTRACT

A dispenser head for a package for dispensing a product which is selected from the group consisting of a cream, a soft solid, and a solid, which comprises: (a) an array of dividers, wherein all of said dividers may be rigid, or all of said dividers may be flexible, or some of said dividers may be rigid and some of said dividers may be flexible; and at least some of said dividers have equatorial cross sections which are wedge-shaped, said cross-sections comprising: i) a tapered end which is disposed toward said product contained within said package; and ii) a blunt end which is disposed away from said product contained within said package; (b) and wherein said array of dividers forms two or more orifices which afford said product a surface area for being dispensed, which is about 40% to about 120% of a cross section of said package normal to flow of product out of said package; (c) and wherein at least some of said blunt ends form at least part of an applicator surface.

### FIELD OF THE INVENTION

The present invention is directed to a dispenser head for a package for dispensing a product such as a cream, soft solid, or solid. More particularly, the invention is directed to a dispenser head that is comprised of an array of dividers which are such that they relieve stress on materials in the package.

### BACKGROUND OF THE INVENTION

Many cosmetic compositions, such as antiperspirants or deodorants, are in the form of creams, soft solids, or solids, which are applied to the surface of the skin of the user. Such compositions are typically packaged in a container that can be cylindrical in shape. The cylinders themselves can have a circular circumference or an oval shaped circumference. The cosmetic composition can be supported by a base that moves vertically within the cylinder. The cosmetic composition can also be supported by a rotating base. As the base is rotated around a screw-like central support (other types of support are also known in the art), the base advances toward the distal end of the cylinder pushing the cosmetic composition toward the distal end of the cylinder.

These platform type dispensers are known for dispensing personal care products such as antiperspirants. One such product that these dispensers have been commonly used for is antiperspirant sticks. The stick product is moved to the upper or dispensing end of the container by the user advancing upward a platform until the material protrudes past the dispenser a sufficient distance for application. After use, if desired, the material can be pushed back into the container by the user. While such antiperspirant sticks are popular, other types of antiperspirant materials have been developed which require alternative dispensing devices. Clear antiperspirant gels and opaque creams have recently been developed which are packaged in platform containers advanced by turning a knob at the lower end of the container to rotate a screw to raise the platform a measured amount. One such dispenser is disclosed in U.S. Pat. No. Re. 34,751. Such containers are equipped with a perforated dome across an open upper end. The antiperspirant is forced through the perforations upon elevation of the platform. A common problem of such dispensers is that after application of the product, residual stress from the initial force exerted upon the material causes syneresis—that is unwanted weeping of liquid from the body of the composition. Another problem is to arrange the perforations of the dispenser head so as to allow for maximum extrusion of cosmetic composition from the perforations of the dispenser head. By achieving such maximal extrusion of cosmetic product, pressure is relieved on the cosmetic product during the dispensing step, further avoiding the likelihood of syneresis of the cosmetic product. Maximum extrusion of the cosmetic product, also enables the consumer to apply the product to the surface of the skin with relative ease and without undue rubbing on the surface of the skin.

Antiperspirant products have recently been developed in the soft solid form that is a more effective antiperspirant than conventional antiperspirant sticks, roll-ons or gels and does not whiten and leave a residue upon the user's skin or clothing. The soft solid material can be a complex fluid with a high number of solids dispersed in a silicone medium, and has the consistency of a thick cream. While this material has been found to be more effective as an antiperspirant, the material creates several challenges in designing a suitable dispenser as previously described.

One performance factor associated with the soft solid material is that it is dilatant. Normal fluids are considered isotropic, that is, pressure applied to a liquid is transmitted equally in all directions throughout the liquid. However, soft solid materials can be anisotropic, in that the stress applied to the material by the platform is transmitted, at least in part, through the solid particles, and not the liquid, and further is not transmitted equally in all directions. This is due to the particles pushing against one another as they try to move in a high particulate volume fraction system. Such behavior is typical of dilatant materials, and results in an increase in viscosity with increasing shear. This is particularly troublesome when the soft solid material is subject to a sudden constriction, such as caused by the perforations in the dispensing end of a conventional platform screw advanced container as previously described. In fact, it has been suggested that some of the stress applied to the soft solid material by the platform is transmitted to the walls of the container, reducing the driving force required to move the material through the package perforations. This reduced stress through the perforations may not be sufficient to induce flow of the material, and requires that the user generate a greater force to dispense the material than would normally be expected.

Another characteristic of the soft solid material is its behavior under stress as a function of time. If dispensed continuously, the material can be extruded without incurring any problems. However, when the material is dispensed in steps, such as the daily application of an antiperspirant where the platform is held in a fixed position after each application, the soft solid material has a tendency to seize. This suggests that the soft solid material remains under stress, even though the flow through the dispensing end has ceased.

Further, it is believed that the residual stress between the solid particles causes them to bond, eventually causing the material to seize inside the container. In addition, this stress increases the tendency for the liquid component of the material to continue to flow, leaving the bonded solids behind.

Attempts to address these performance factors have concentrated on releasing the residual stress. One approach is to use a spring, similar to that used in caulking guns, where the spring pushes the platform away from the material being dispensed. A variation of this approach is to use a feed screw and a spring in conjunction with the platform, where the spring reverses the rotation of the feed screw, retracting the platform. One problem inherent with this latter approach is the unpredictability of the amount of retraction that will occur. The amount of retraction, and thus the amount of residual stress remaining in the material, will depend on the material dispensed, age of the material and the container, type of spring, friction, etc. There is no assurance that the amount of retraction will be sufficient to prevent weeping, and there is no assurance that this type of container will retract the platform sufficiently to remove all residual stress in the material.

Yet another approach is to use a feed screw in conjunction with internal cams. The feed screw advances the platform a set distance upward, after which the internal cams retract the platform a lesser distance to relieve pressure on the material. While this approach allows the amount of retraction to be predicted, the distance of retraction of the platform is not determined by the residual stress, but by the configuration of the internal cams. Since the internal cams only allow the platform to retract a set distance, it is conceivable that not all the residual stress in the material is relieved, resulting in the weeping problem discussed above.

Moreover, the approaches set forth above are relatively expensive, and require the manufacture and assembly of springs, feed screws and/or the internal cams in addition to product in the containers and materials.

Accordingly, an object of the present invention is to provide an improved dispensing container that sufficiently relieves the stress in the material and prevents or makes the soft solid material less prone to syneresis.

Other objects and advantages of the invention will become apparent from the following description and accompanying drawings.

### SUMMARY OF THE INVENTION

The present invention relates to a dispenser head for a package for dispensing a product which is selected from the group consisting of a cream, a soft solid, and a solid, which comprises:
(a) an array of dividers, wherein all of said dividers may be rigid, or all of said dividers may be flexible, or some of said dividers may be rigid and some of said dividers may be flexible, the dividers comprising:
   i) a tapered end which is disposed toward said product contained within said package; and
   ii) a blunt end which is disposed away from said product contained within said package;
(b) and wherein the array of dividers forms one or more orifices which afford the product a surface area for being dispensed, which is about 40% to about 120% of a cross section of the package normal to flow of product out of the package;
(c) and wherein at least some of the blunt ends form at least part of an applicator surface.

To enable a product to be dispensed through an open surface area that is about 40% to about 120% of the surface of a cross section normal to the flow of product within the package, the dispenser head is constructed of an applicator surface which has two or more orifices that provide the required surface area for the product.

The present invention embraces all arrangements of orifices which provide for an open surface area that is about 40% to about 120% of the surface of a cross section normal to the flow of product within said package. Preferably, the arrangement of orifices provide for an open surface area of about 85% to about 120%, and more preferably about 90% to about 120%, and including all ranges subsumed therein, of the surface area of a cross-section normal to the flow of product within the package. The surface area of a cross-section normal to the flow of product within the package shall be the cross sectional area at the point where the product exits the package and enters into the dispenser head. In an embodiment where the dispenser head and package are molded as one piece, then the surface area of a cross-section normal to the flow of product within the package shall be the cross sectional area at the upper edge of the outer wall of the dispenser head.

All percentages in this specification and claims, unless indicated otherwise, are intended to be percentages by weight.

All numerical ranges in this specification and claims are intended to be modified by the term about.

As used herein, the term “comprising” means that a specified material or element is present, optionally together a further material or element, and includes including, made up of, composed of, consisting and/or consisting essentially of.

For a more complete understanding of the above and other features and advantages of the invention, reference should be made to the following detailed description of preferred embodiments and to the accompanying drawings.

### DESCRIPTION OF THE FIGURES

FIG. 1 is a perspective view of an embodiment of a dispenser head of the invention.

FIG. 2 is a bottom view of a portion of the dispenser head of the embodiment of the invention depicted in FIG. 1.

FIG. 3 is cross-sectional view of a fragment of an embodiment of the dispenser head of the invention depicted in FIG. 1.

FIG. 4 is a perspective view of a tetrahedrally shaped fragment of an embodiment of a dispenser head of the invention.

FIG. 5 is a perspective view of another embodiment of a dispenser head of the invention.

FIG. 6 is a perspective view of another embodiment of a dispenser head of the invention with product shown in the dispenser head.

FIG. 7 is a perspective view of another embodiment of a dispenser head of the invention.

### DETAILED DESCRIPTION OF THE INVENTION

Referring now to the figures herein, the construction and operation of dispenser heads and packages of the invention are described with more particularity.

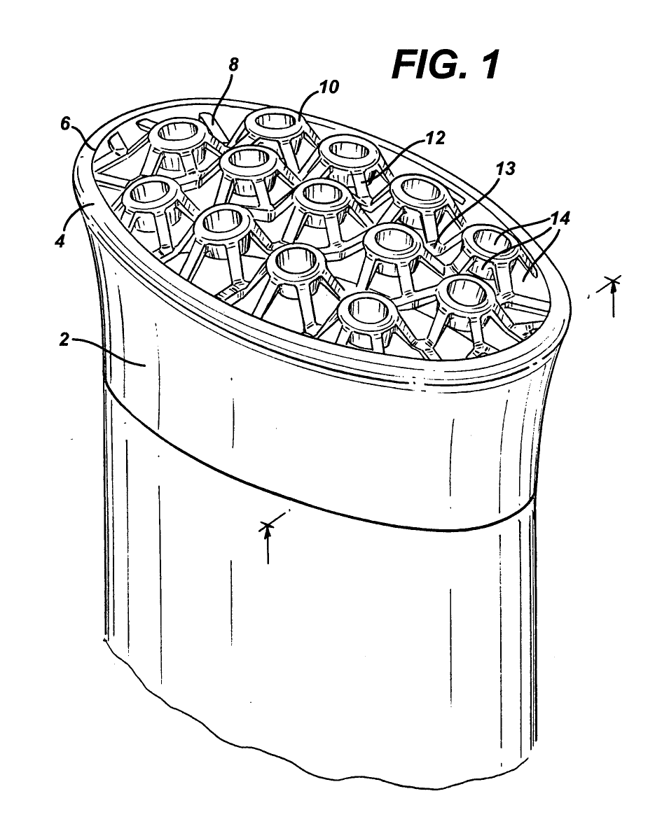

Referring to FIG. 1, an embodiment of a dispenser head of the invention which has an exterior wall, 2, is shown. Adjacent to this exterior wall, 2, is a curved peripheral applicator surface, 4, which ends at an inner edge of applicator, 6. Attached to a surface of exterior wall, 2, at or below the inner edge of applicator, 6, are spokes, 8, which can connect to circular applicator surfaces, 10. The circular applicator surfaces need not necessarily be circular and may be any shape desired. The spokes 8 are disposed at various acute angles, relative to a cross section of the applicator surface and so as to point above the cross section of the applicator surface and away from the product. Circular applicator surfaces, 10, are in turn connected to each other by interior spokes, 12 which are disposed at various acute angles, relative to a cross section of the applicator surface and so as to point above the cross section of the applicator surface and away from the product. Interior spokes, 12, in contrast to spokes, 8, are not attached to the inner edge of applicator, 6. Multiple interior spokes, 12, can also join at juncture 13. The combination of applicator surfaces, 10, and spokes 12 and 8, form a honeycombed shaped pattern over the surface of the dispenser head. Below each circular application surface, 10, extends a tubular projection, 16. Together, circular applicator surfaces, 10, and curved peripheral applicator surface, 4, comprise the applicator surface for this particular dispenser head of the invention. Spokes 8 and 12 and circular applicator surfaces 10 all are dividers in this embodiment. Spokes 8 and 12 along with applicator surfaces 4 and 10 form orifices 14 through which product flows when being dispensed.

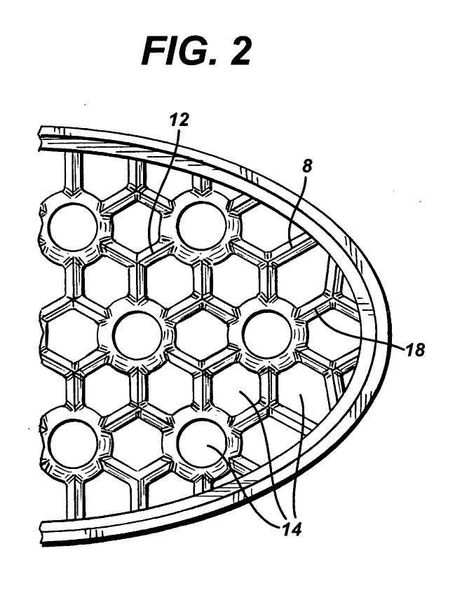

FIG. 2 represents the underside of the embodiment of a dispenser head of the invention as shown in FIG. 1. As can be seen, the dividers of this embodiment form a honeycomb structure. Spokes 12 and 8, are disposed toward the product within the package. As product is dispensed through this embodiment of a dispenser head of the invention, it is divided by blades 18, and caused to flow through orifices 14 formed by spokes 8 and 12 and applicator surfaces 4 and 10, and out of the dispenser head.

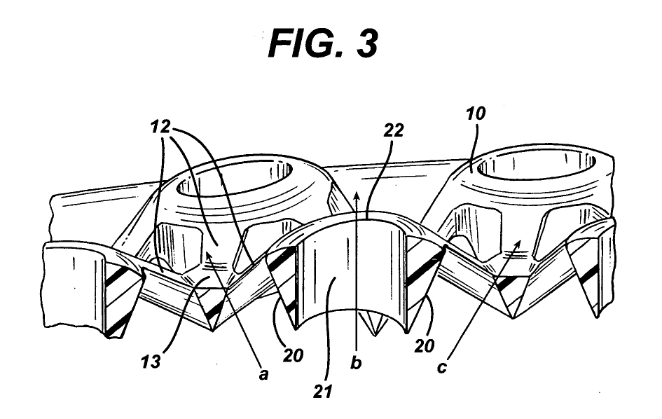

FIG. 3 shows a fragment of the honeycombed structure dispenser head shown in the FIG. 1. FIG. 3 reveals how this embodiment of the invention functions to provide a large open surface area for escape of cosmetic product relative to a cross-section normal to the flow of product within the lower part of the package. It can be seen that application surface, 10, forms a tube shaped opening whose inner wall is wall, 22. Application surface, 10, flares outwardly until it intersects a tapering straight line wall, 20, which in turn intersects with inner tubular wall, 22, to form an inner ring, 21.

Three spokes, 12, join at juncture, 13, to connect three applicator surfaces, 10. The inner surface of spoke, 12, and the tapering surface, 20, forms an orifice which is at an acute angle from the normal of the cross section of the applicator head. Similarly, the tubular opening surrounded by inner wall, 22, forms an opening for cosmetic product which is approximately 90° to the normal of the applicator surface. The surface areas indicated by the axes denoted (a), (b) and (c) are added together, form a large surface area as compared to the surface area of a cross-section which is normal to the flow of product within the lower part of the package.

This orifice arrangement helps to provide for the many benefits of this embodiment of the dispenser head of the invention. In addition, application surfaces, 10, provide a suitable surface for the user to rub against the skin such as the underarm area in applying cosmetic compositions of the present invention using this particular embodiment of the dispenser head of the present invention.

The hole size in the orifices formed from applicator surfaces, 10, and spokes, 12, may be varied depending upon the nature of the soft solid, solid, or cream which is being dispensed from this embodiment of the dispenser head of the invention, in order to optimize the dispensing of the particular cosmetic product in the package.

In order to minimize syneresis of, for example, soft solid compositions which are dispensed using dispenser heads of the invention, it is desirable to minimize the length surfaces, 20 and 22. It has also been found that it is desirable that surfaces, 20 and 22, be in the form of flat surfaces in order maximize product dispension; and it has further been found desirable for surfaces, 20 and 22, to come together beneath the top of application surface, 10, in the shape of a small “v”. When surfaces, 20 and 22, are in the form of curves so as together to form a small “u”, dispensing of cosmetic product is more inhibited.

If inner tubular wall surface, 21, is curved inwardly so as to form a dome shape which has a smaller opening at the top, than at the bottom, dispensing of cosmetic product is lessened.

In addition, it is been found that if an arrangement of dividers presents a flat obstruction which is perpendicular to the flow of product from below and within the package, and if cosmetic product is made to escape around this flat obstruction, then the dispensing of cosmetic product is made difficult. It is preferred that the bottom surface of the dividers (i.e. the surface that faces the product in the package) is in the shape of a wedge (i.e. in the shape of a “v”) as opposed to a more blunt shape (i.e. such as a “u”). As previously stated, this type of structure is less inhibiting to the product flow. These “v” shaped structures may be referred to as blades. Accordingly, the “v” shaped structure of the bottom surface of the dividers as shown in FIG. 2 make dispensing of product much easier and places the product under less residual stress thus decreasing the likelihood of syneresis.

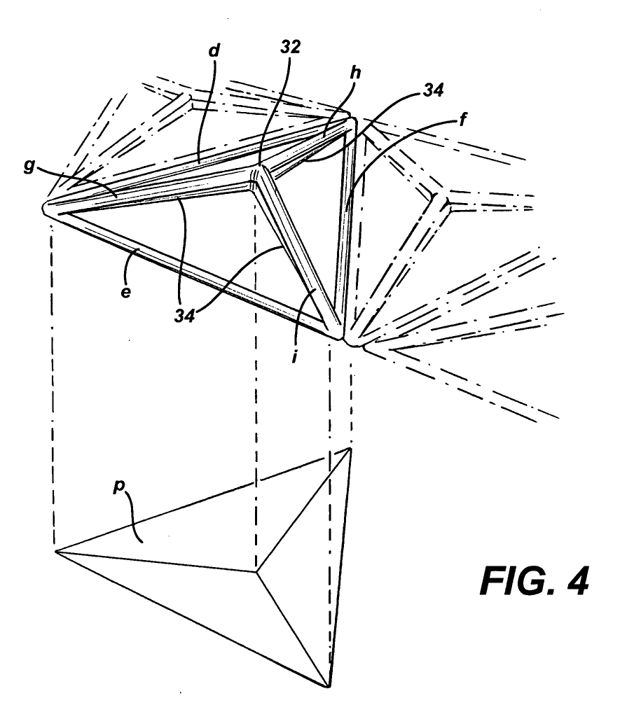

FIG. 4 shows a fragment of an embodiment of a dispenser head of the invention. This fragment contains three adjacent orifices. This fragment is tetrahedrally shaped. Below this fragment is shown its projection, P, onto a flat surface. The sides of the triangle of this projection are labeled respectively, d, e, and f. At its interior and projecting upwardly are three edges, g, h, and i, which meet to form the point of that tetrahedron, 32.

It can be seen that blades, 34, attached to edges, g and h, for example, are present to divert antiperspirant deodorant product as it flows through the opening in this vent arrangement.

If every side (d, e, and f) in this fragment were 1 cm long and cosmetic product were flowing at right angles through the projected triangular shape, P, the open surface area available for flow of product would equal ½×0.866 cm×1 cm, which is 0.433 cm². However, in the case of the tetrahedrally shaped vent formed by the three triangles shown, the surface area for flow of product is approximately the surface area of the sum of the openings of each of the three triangles formed by the tetrahedron shape. This surface area would be 1.299 cm², which is considerably greater. This greater surface maximizes and eases the dispensing of the cosmetic product, and minimizes the stress on the cosmetic product and thereby minimizes the chances for syneresis of the cosmetic product to occur.

Again, because these three triangles have surface areas that are together greater than the surface area of the flat projection below, it can be seen that this embodiment of the dispenser head of the invention can provide an open surface area for flow of antiperspirant deodorant product which is greater than the surface area which is provided by a projection of a cross-section which is normal to the flow of the product within the lower sections of the package.

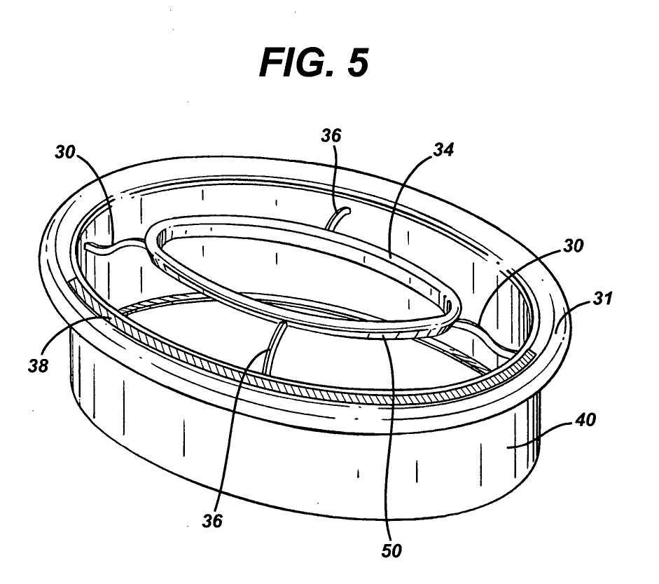

FIG. 5 refers to another embodiment of a dispenser head of the invention. This embodiment has an exterior wall of the applicator, 40, which connects to an applicator flare, 31, and forms an elliptically shaped opening. On one long side of this oval shaped applicator is embedded a groove, 38, for collecting product which may be dispensed. Two flexible spokes 30 are attached in the direction of the major axis of the oval to an inner applicator surface, 34. Non-flexible or rigid spokes, 36, are attached to inner applicator surface, 34, in the direction of the minor axis to the oval shaped application surface, 34. Application surface 34 has blades 50 which direct product as it flows out of the dispenser head.

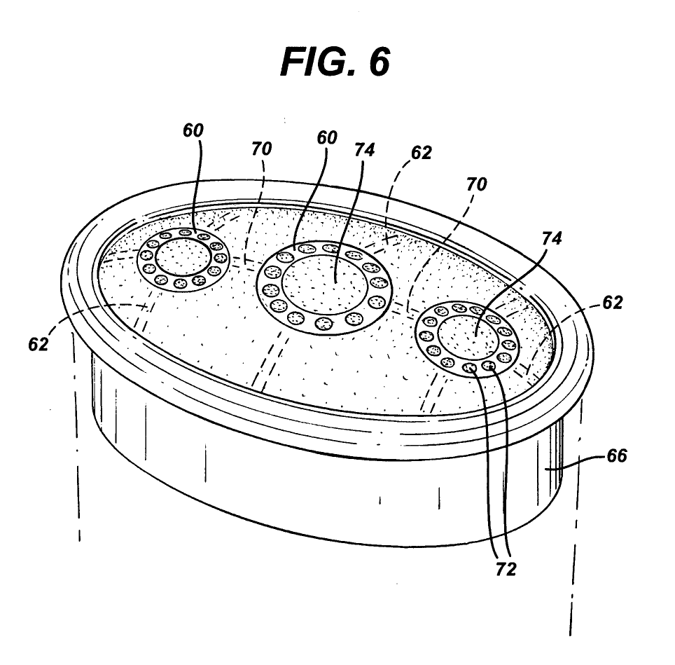

FIG. 6 shows yet another embodiment of a dispenser head of the invention. This embodiment is depicted with product in its open surface areas which product may flow through when being dispensed. It possesses an applicator surface 64, an exterior wall of the applicator 66, and series of spokes 62 which attach the applicator surface 64 to floating heads 60 which also act as applicator surfaces. Spokes, 70, connect the two peripheral floating heads to inner floating heads. Each floating head has a series of baskets, 72, and a larger inner circular area, 74, through which antiperspirant and deodorant product flows upon use of the dispenser head. Blades as describe previously extend downwardly from the baskets in floating heads/application surface 60. Blades also extend downwardly from the inner larger circular area shown in the floating heads/application surface 60. As product flows from the dispensing package through the dispenser head of the invention, it is directed into different directions, thereby allowing for the greater open surface area for product that is characteristic of the present invention.

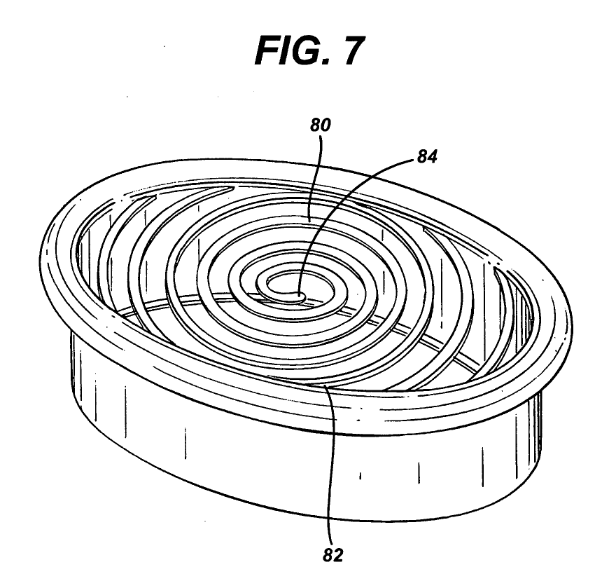

FIG. 7 shows another example of the invention. This embodiment has an arrangement of orifices wherein a single primary orifice is formed by a spiral of flexible material which forms the applicator surface of the dispenser head. The spiral 80 begins at an inner sidewall 82 of the dispenser head, and continues inwardly to the center 84 of the applicator surface. Other smaller orifices are formed by additional dividers. When product is extruded through the dispenser head, the rings that make up the spiral, distend, so as to leave an opening for the product which is greater than the horizontal surface area of the package. The rings toward the center of the spiral distend a greater distance than the rings on the periphery of the spiral.

It will be appreciated that alternate embodiments of this floating head dispenser can also be achieved. For example, instead of having three separate rings of application surface there can be one large oval or elliptical shaped ring which fits within the application flare and which is attached to the application flare by rigid spokes or flexible spokes or by a combination of both rigid and flexible spokes.

It will also be appreciated that product dispensing can be improved by providing for a flare or outwardly disposed angle to the dispenser head just at the surface of application as shown in FIG. 1. In other words, the dispenser head can be made to flare beyond the diameter of the package body.

Additional nonlimiting examples (not shown) of such arrangements of orifices include a grid which is non-planar, but instead has its openings arranged on a surface of hills and valleys such that the total open surface area of the these orifices may be greater than the horizontal cross section of the package. When product is extruded through the orifices of such a grid, it is extruded in different directions depending upon the location of the particular orifice in the grid.

Yet another example (not shown) of such an arrangement of orifices is a series of parallel strips of flexible material which extend lengthwise across the opening of the package. Again, when product is extruded through the dispenser head, the parallel strips of flexible material, distend, so as to leave an opening for the product which can be greater than the horizontal surface area of the package. The strips which run across the central portion of the opening of the package, separate from each other, during extrusion of product, a greater distance than the strips that are toward the outside of the opening.

It will be appreciated that what has been described above are a number of embodiments of the dispenser head of the present invention. Other dispenser heads are intended to be covered and fall within the scope of the present invention.

In order for the dispenser heads of the invention to most efficiently function, it is necessary that these dispenser heads present a certain application surface to the user. An application surface is expressed as a percent of the cross-sectional area normal to the dispensing direction of product flow within the lower part of the package. Application surface is the portion of the dispenser head that is in a contact with the skin during one swipe or stroke in one direction. The application surface is useful in applying product as well as rubbing the product onto a surface (e.g. skin) once the product is dispensed. The application surface of a dispenser head of the invention as a percentage of the cross-sectional area normal to the flow of product within lower part of the package can range from about 10% to about 70%, more preferably about 10% to about 50%, and most preferably about 20% to about 50%, and including all ranges subsumed therein.

While the above invention has been described with respect to the use of either solid, soft solid or cream antiperspirant/deodorant compositions, it will be appreciated that the dispenser head of the invention can be employed with any product of the appropriate consistency and viscosity. For example, it is contemplated that dispenser heads of the present invention may be employed with other cosmetic products such as sunscreens, soaps, lipsticks, lip balms, make-up, as well as industrial products such as glues, pastes and other such ingredients, as well as medicinal compositions such as antibacterial ointments, topical anesthetics, and the like.

A dispenser head and package of the invention can be used to contain a cosmetic antiperspirant and deodorant product such as:

| Component | Weight % |
|---|---|
| Cyclomethicone | 29.7 |
| GE 1229 | 13.5 |
| Polydecene 364 | 10.8 |
| AZAG | 26.0 |
| Corn starch | 20.0 |

Dispenser heads of the present invention may be made of materials which are known in the art for the construction of dispenser heads in cosmetic packages. Such materials include any rigid plastic material suitable for stretch or blow molding, or injection molding. Such rigid plastics include, but are not limited to plastics selected from the group consisting of thermoplastic elastomers, polypropylenes, and polyethylene terepthalate.

Dispenser heads of the invention, are, as indicated above, sometimes also constructed of flexible materials. Such materials, include, but are not limited to, materials selected from the group consisting of flexible plastics and rubber.

Dispenser heads and packages can be made by injection molding methods which are either known in the art, or by other methods which are known to the art. Such methods include, but are not limited to those set forth in U.S. Pat. No. Re 34,751 which is hereby incorporated by reference.

It should be understood, of course, that the specific forms of the invention herein illustrated and described are intended to be representative only, as certain changes may be made therein without departing from the clear teachings of the disclosure. Accordingly, reference should be made to the following appended claims in determining the full scope of the invention.

1. A dispenser head for a package for dispensing a product which is selected from the group consisting of a cream, a soft solid, and a solid, which comprises:
(a) an array of dividers, wherein all of said dividers may be rigid, or all of said dividers may be flexible, or some of said dividers may be rigid and some of said dividers may be flexible; the dividers comprising:
i) a tapered end which is disposed toward said product contained within said package; and
ii) a blunt end which is disposed away from said product contained within said package;
(b) and wherein the array of dividers forms two or more orifices which afford the product a surface area for being dispensed, which is about 40% to about 120% of a cross section of the package normal to flow of product out of the package;
(c) and wherein at least some of the blunt ends form at least part of an applicator surface.

2. A dispenser head in accordance with claim 1, wherein said orifices provide said product with an open surface area of about 85 to about 120% of the surface area of a cross-section normal to the flow of product within the package.

3. A dispenser head in accordance with claim 1, wherein said orifices provide said product with a open surface area of about 90 to about 120% of the surface area of a cross-section normal to the flow of product within said package.

4. A dispenser head in accordance with claim 1, wherein said applicator surface has an application surface of about 10 to about 70% of a cross-section of said package normal to the flow of product within the package.

5. A dispenser head in accordance with claim 1, wherein said applicator surface has an application surface of about 20 to about 50% of a cross-section normal to the flow of product within the package.

6. A dispenser head in accordance with claim 1, wherein said dispenser head comprises a plastic selected from the group consisting of polypropylenes, high density polyethylenes, and thermoplastic elastomers.

7. A dispenser head according to claim 1, which comprises an exterior wall connected to:
(a) an applicator flare which is connected to;
(b) an inner edge of said applicator flare;
(c) which is connected to a series of spokes which are roughly horizontal to the plane of the applicator surface, which are in turn connect to;
(d) a series of spokes which are at about a 45° angle to the applicator surface;
(e) which are in turn connected to an open basket, each such basket comprising a top circular application surface with an inner cylindrical surface, said top surface having a flare which intersects a tapering straight line surface which comes to a point when it intersects with the inner cylindrical surface, and
(f) wherein said spokes and open baskets form a network.

8. A dispenser head in accordance with claim 1, which comprises an exterior wall which is oval shaped and which is connected to a flared applicator surface which in turn is connected to one or more spokes selected from the group consisting of flexible and rigid spokes and mixtures thereof, wherein said spokes are in turn connected to an oval applicator surface ring having straight line blades on its sides.

9. A dispenser head in accordance with claim 1, which comprises an exterior wall of an applicator which is connected to a flared applicator surface which in turn is connected to one or more rigid or flexible spokes which are in turn connected to one or more rings containing applicator surface baskets.
